(19) United States
(12) Patent Application Publication
(10) Pub. No.: US 2007/0291677 A1
(43) Pub. Date: Dec. 20, 2007

(54) Method and Apparatus to Facilitate Establishing a Non-Home Agent-Facilitated Interactive Real-Time Session

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTSTARCOM, INC., Alameda, CA (US)

(21) Appl. No.: 11/424,342

(22) Filed: Jun. 15, 2006

(51) Int. Cl. H04Q 7/00

(52) U.S. Cl. 370/328

(57) ABSTRACT

A packet data serving node (200) that receives (101) from a mobile station (408) that already has an existing home agent-facilitated data session an indication of a present need to conduct an interactive real-time session is able to establish (102) a non-home agent-facilitated interactive real-time session for that mobile station notwithstanding and apart from the existing home agent-facilitated data session. By one approach this can comprise treating traffic as corresponds to the non-home agent-facilitated interactive real-time session as simple Internet Protocol traffic while treating traffic as corresponds to the existing home agent-facilitated data session as mobile Internet Protocol traffic. If desired, different Internet Protocol address can be used to facilitate such treatment alternatives. By one approach, the aforementioned packet data serving node assigns the Internet Protocol that the mobile station uses in conjunction with the non-home agent-facilitated interactive real-time session.

### TECHNICAL FIELD

This invention relates generally to communications and more particularly to the establishment of an interactive real-time session for a mobile station.

### BACKGROUND

Facilitated communications, including both real-time and non-real-time communication sessions, are known in the art. By one approach (employed, for example, with certain code division multiple access (CDMA)-based systems), both home agents and packet data serving nodes are located in a core network. The core network, in turn, couples to one or more access networks having a network edge that couples to local radio network controllers, media gateways, and so forth. So configured, a mobile station using mobile Internet Protocol can facilitate its communications by using a home agent-facilitated data session.

For many purposes this approach works well. Consolidation of many architectural elements in the core network can lead to reduced capital expenditure, for example. For other purposes, however, such an approach can lead to problems. Next generation wireless voice-over-Internet Protocol (VoIP) technologies (such as Evolution Data Only (EVDO) revision A), for example, supports VoIP services in a CDMA network. The efficiency of the EVDO air interface, however, can depend greatly on the end-to-end application latency. When this latency approaches a relatively high value (such as, for example, 250 ms roundtrip), the air interface capacity can be significantly reduced. For example, reductions of up to one-half appear possible.

Air interface capacity comprises a relatively limited resource. Such degradation of air interface capacity therefore constitutes a potentially important problem. Unfortunately, the aforementioned architectural choices and corresponding call routing behaviors can contribute significantly to end-to-end application latency when supporting real-time services such as VoIP. Such latency is owing, at least in part, to the significant backhaul requirements posed by the home agent-centric foundation of these approaches.

Mobile Internet Protocol version 6 avoids, in large measure, such problems. Unfortunately, Mobile Internet Protocol version 6 comprises a relatively recent standard that will require extensive upgrades throughout the communication fabric. Such upgrades may be some time in being fully implemented.

### BRIEF DESCRIPTION OF THE DRAWINGS

The above needs are at least partially met through provision of the method and apparatus to facilitate establishing a non-home agent-facilitated interactive real-time session described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a block diagram as configured in accordance with various embodiments of the invention; and

FIG. 5 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments a packet data serving node that receives from a mobile station that already has an existing home agent-facilitated data session an indication of a present need to conduct an interactive real-time session is able to establish a non-home agent-facilitated interactive real-time session for that mobile station notwithstanding and apart from the existing home agent-facilitated data session.

By one approach this can comprise treating traffic as corresponds to the non-home agent-facilitated interactive real-time session as simple Internet Protocol traffic while treating traffic as corresponds to the existing home agent-facilitated data session as mobile Internet Protocol traffic (where those skilled in the art will recognize that “mobile Internet Protocol” refers here to Internet Protocol version 4). If desired, different Internet Protocol address can be used to facilitate such treatment alternatives. By one approach, the aforementioned packet data serving node assigns the Internet Protocol that the mobile station uses in conjunction with the non-home agent-facilitated interactive real-time session.

So configured, ordinary data communications are processed via the mobile station's home agent in accordance with prior art practice in this regard. Interactive real-time needs, however, such as voice-over-Internet Protocol are accommodated via a packet data serving node while avoiding undue usage of the home agent. This, in turn, can lead to significant reduction with respect to end-to-end latency (particularly when locating such a packet data serving node within an access network rather than within the core network).

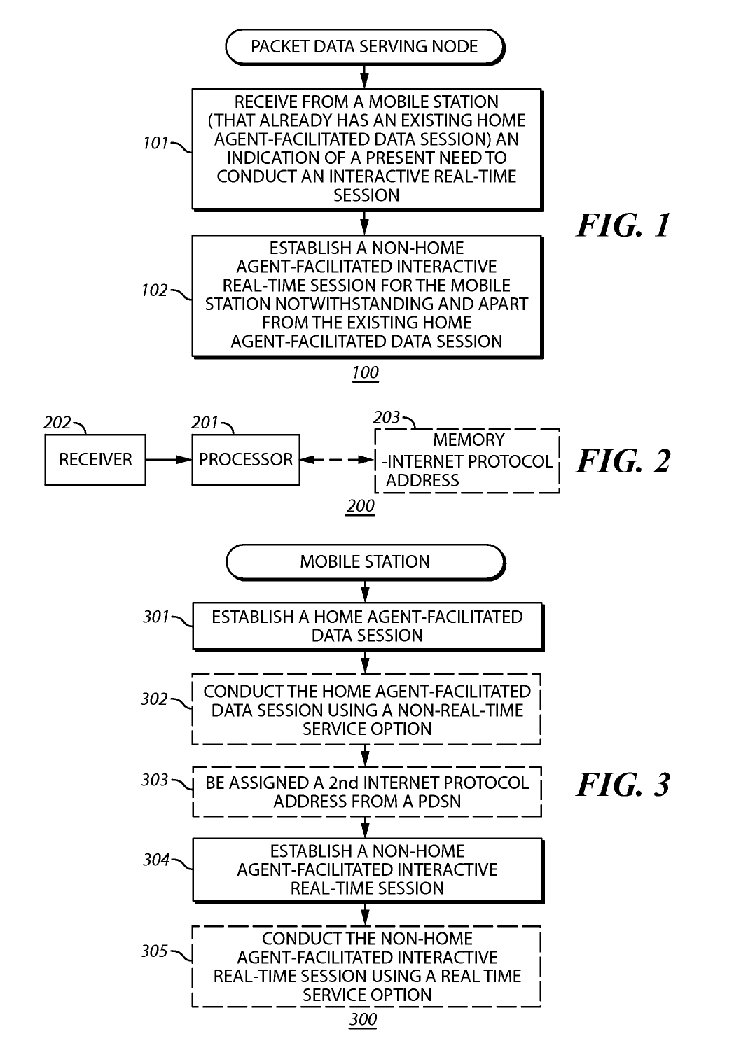

These and other benefits may become clearer upon making a thorough review and study of the following detailed description. Referring now to the drawings, and in particular to FIG. 1, by these teachings a packet data serving node can effect a process 100 that supports receiving an indication of a present need to conduct an interactive real-time session for a mobile station. The interactive real-time session can comprise, but is not limited to, a voice-over-Internet Protocol session as is known in the art.

This indication will typically be sourced by the mobile station itself and may comprise, for example, an interactive real-time call setup message. This mobile station will already typically have an existing home agent-facilitated data session. By one approach the mobile station has used a mobile Internet Protocol address to facilitate establishment and/or usage of this home agent-facilitated data session.

This process 100 also provides for establishment 102, by the packet data serving node, of a non-home agent-facilitated interactive real-time session for the mobile station notwithstanding and apart from the existing home agent-facilitated data session. This, of course, runs contrary to conventional practice in this regard. In substance and effect, the packet data serving node treats traffic as corresponds to the non-home agent-facilitated interactive real-time session as simple Internet Protocol traffic while treating traffic as corresponds to the existing home agent-facilitated data session as mobile Internet Protocol traffic.

As noted above, the mobile station may use a first Internet Protocol address, such as a mobile Internet Protocol address, for calls as pertain to the home agent-facilitated data session. If desired, it may be useful to have the mobile station use a second, different Internet Protocol address (such as a simple Internet Protocol address) when establishing and/or using the non-home agent-facilitated data interactive real-time session. Accordingly, if desired, this step of establishing 102 the non-home agent-facilitated data interactive real-time session can comprise having the packet data serving node assign that second Internet Protocol address to the mobile station.

Such an assignment can be realized using any suitable technique in this regard. For example, such an assignment can be made by using an Internet Protocol Control Protocol-based Internet Protocol address allocation process, a Remote Authentication Dial-In User Service-based Internet Protocol address allocation process, a Dynamic Host Configuration Protocol-based Internet Protocol address allocation process, or the like (all of which are well known in the art and require no further elaboration here).

If desired, establishment of the home agent-facilitated data session can comprise using a non-real-time service option such as, but not limited to, SO59 as is known in the art. Also if desired, establishment of the non-home agent-facilitated data interactive real-time session can comprise using a real-time service option such as, but not limited to, SO67 as is also known in the art. So configured, Real-time Transport Protocol (RTP) messages that use the real time service option and that bear interactive real-time content (such as, but not limited to, VoIP content) will be routed directly to a target destination rather than through a home agent for the mobile station as occurs with the home agent-facilitated data session.

As suggested by the illustration of FIG. 1, the step of establishing 102 the non-home agent-facilitated data interactive real-time session can occur subsequent to the step of receiving 101 the aforementioned indication of need from the mobile station. If desired, however, these teachings are also applicable in a reversed order. For example, the step of establishing 102 the non-home agent-facilitated data interactive real-time session can occur prior to the step of receiving 101 this indication of need from the mobile station.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment a packet data serving node 200 comprises a processor 201 that operably couples to a receiver 202. The latter is configured and arranged (using, for example, known technique and practice in this regard) to receive from a mobile station that already has an existing home agent-facilitated data session an indication of a present need to conduct an interactive real-time session. As noted above, this can comprise, if desired, receiving an interactive real-time call setup message.

The processor 201 is configured and arranged to carry out the teachings set forth herein. In particular, this comprises establishing a non-home agent-facilitated data interactive real-time session for the mobile station notwithstanding and apart from the existing home agent-facilitated data session. As noted above, this can comprise using different Internet Protocol addresses for these different sessions. To support this approach, if desired, the packet data serving node 200 can further comprise a memory 203 that operably couples to the processor 201 and that stores, for example, the aforementioned second Internet Protocol address.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, a packet data serving node is able to support a real-time application, such as voice-over-Internet Protocol, in a manner that avoids imposing backhaul responsibilities upon a core network. This, in turn, can significantly reduce corresponding end-to-end latency. As a result, air interface capacity will more likely support a greater user population.

By one approach the mobile station can be configured and arranged to compatibly support such functionality. With reference to FIG. 3, this can comprise a process 300 that provides for establishing 301, at a given mobile station, a home agent-facilitated data session as has already been described above (using, for example, a corresponding Internet Protocol address). This, in turn, permits the mobile station to optionally employ 302 that home agent-facilitated data session when using, for example, a non-real-time service option.

This process 300 can also optionally provide for assigning 303 this mobile station a second Internet Protocol address. As noted, this second Internet Protocol address can be assigned by the aforementioned packet data serving node and may comprise, for example, a simple Internet Protocol address rather than a mobile Internet Protocol address as was likely used for the home agent-facilitated data session Internet Protocol address.

This process 300 then provides for establishing 304 a non-home agent-facilitated data interactive real-time session notwithstanding and apart from the existing home agent-facilitated data session. So configured and arranged, the mobile station is then able to optionally conduct 305 a non-home agent-facilitated data interactive real-time session using, for example, a corresponding real-time service option such as, but not limited to, SO67.

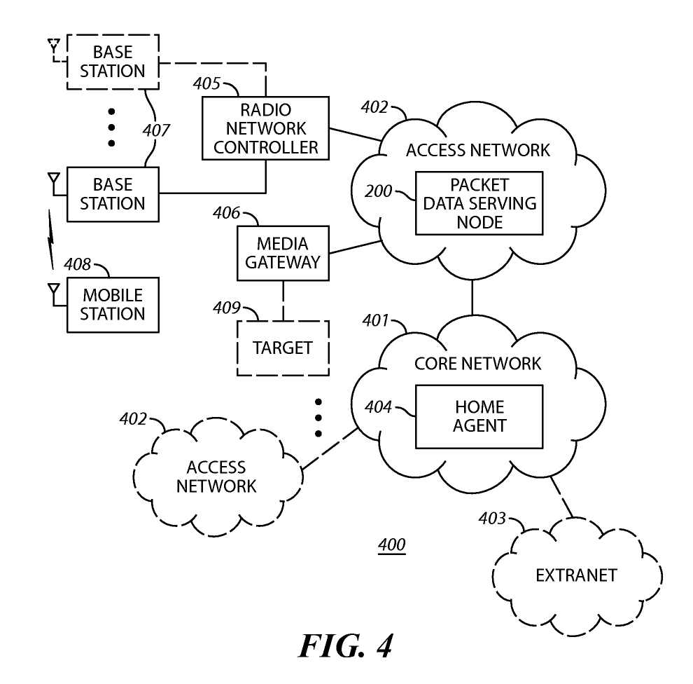

With reference now to FIG. 4, these teachings are readily implemented in conjunction with, for example, a given communications system 400 that comprises a core network 401 that couples to one or more access networks 402 (and other networks of choice including, but not limited to, an extranet 403 such as the Internet). The core network 401 may comprise, in part, a home agent 404 as is known in the art. By these teachings, however, if desired, the corresponding packet data serving node(s) 200 may be physically located within one or more of the access networks 402 rather than the core network 401.

In general accordance with ordinary practice, each access network 402 can couple at its edge to one or more radio network controllers 405, media gateways 406, and so forth (with only one such example of each being illustrated here for the sake of simplicity and clarity). Such radio network controllers 405, in turn, couple to and control one or more wireless base stations 407 (for example, CDMA-compatible wireless base stations as are known in the art).

In accordance with these teachings, a given mobile station 408 that already has a home agent-facilitated data session can further establish, via the packet data serving node 200, a non-home agent-facilitated data interactive real-time session with a given target 409 such that a real-time service (such as VoIP) can be conducted there between without requiring the content bearing packets to pass through the home agent 404 or even the core network 401. Instead, in the particular example shown, these real-time service content bearing packets can instead pass from the mobile station 408 to the target 409 via only the intervening access network 402. This, of course, aids with minimizing overall end-to-end latency as would otherwise be experienced when including the core network 401 in such a flow.

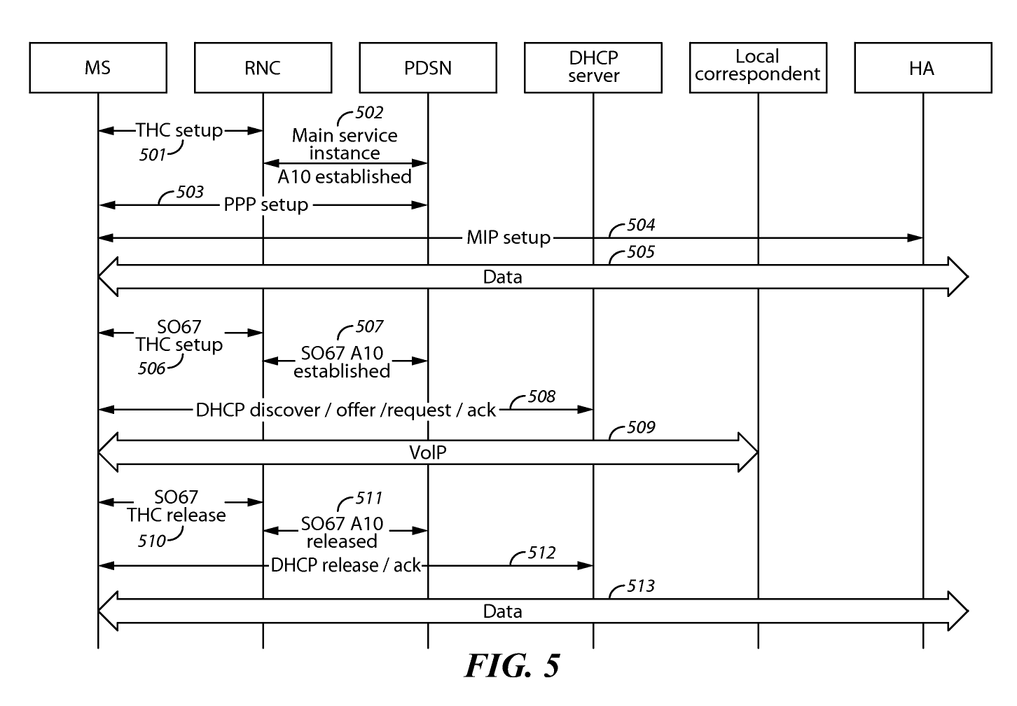

With reference to FIG. 5, a call flow diagram serves to provide a sample illustrative example in this regard. Those skilled in the art will recognize that this example serves an illustrative purpose only and that numerous other examples as would correspond to these teachings might also be presented.

In this illustrative example, a mobile station (MS) establishes a transmission channel (TCH) 501 with a corresponding radio network controller (RNC). The RNC then establishes an A10-based main service instance 502 with a corresponding packet data serving node (PDSN). The MS and PDSN then setup a point-to-point protocol (PPP) session 503 following which the MS uses mobile Internet Protocol (MIP) 504 with its home agent (HA) to establish a home agent facilitated data session 505. Those skilled in the art will recognize this flow, to this point, as comporting with ordinary prior art practice in this regard.

By these teachings, however, in this illustrative embodiment the MS then uses SO67 to setup another transmission channel 506 with the RNC, following which the RNC establishes an SO67 A10 session with the PDSN. In this particular illustrative example, the MS then communicates with a dynamic host configuration protocol (DHCP) server (comprising discover, offer, request, and acknowledgement actions 508 as are known in the art) to thereby establish a VoIP session 509 with a local correspondent that comprises the mobile station's communication target. These actions of course vary considerably as compared to ordinary prior art practice in this context.

Upon concluding the VoIP session 509, the MS (again using SO67) releases 510 the transmission channel with the RNC. The RNC then similarly releases 511 the previously established A10 session following which the MS and DHCP server release 512 their context. As the VoIP session was established, conducted, and torn down independent of the early established host agent-facilitated data session 505, the latter continues 513 notwithstanding having torn down the VoIP session.

Latency improvements can be significant by observation and application of these teachings. At the same time, only relatively minor changes need be made with respect to only certain network elements in order to attain such improvement. If desired, in fact, these teachings are readily implemented using only existing communications protocols, hence avoiding a need to implement or revise existing standards or to promulgate a new standard.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a packet data serving node:
receiving from a mobile station that already has an existing home agent-facilitated data session an indication of a present need to conduct an interactive real-time session;
establishing a non-home agent-facilitated interactive real-time session for the mobile station notwithstanding and apart from the existing home agent-facilitated data session.

2. The method of claim 1 wherein establishing a non-home agent-facilitated interactive real-time session for the mobile station comprises using a different Internet Protocol address for the mobile station than is used for the existing home agent-facilitated data session.

3. The method of claim 2 wherein using a different Internet Protocol address for the mobile station than is used for the existing home agent-facilitated data session comprises assigning the different Internet Protocol address to the mobile station.

4. The method of claim 3 wherein assigning the different Internet Protocol address to the mobile station comprises assigning the different Internet Protocol address using at least one of:
an Internet Protocol Control Protocol-based Internet Protocol address allocation process;
a Remote Authentication Dial-In User Service-based Internet Protocol address allocation process;
a Dynamic Host Configuration Protocol-based Internet Protocol address allocation process.

5. The method of claim 1 wherein establishing a non-home agent-facilitated interactive real-time session for the mobile station notwithstanding and apart from the existing home agent-facilitated data session comprises:
treating traffic as corresponds to the non-home agent-facilitated interactive real-time session as simple Internet Protocol traffic;
treating traffic as corresponds to the existing home agent-facilitated data session as mobile Internet Protocol traffic.

6. The method of claim 1 wherein receiving from a mobile station that already has an existing home agent-facilitated data session an indication of a present need to conduct an interactive real-time session comprises receiving from the mobile station a interactive real-time call setup message.

7. The method of claim 1 wherein establishing a non-home agent-facilitated interactive real-time session for the mobile station notwithstanding and apart from the existing home agent-facilitated data session comprises using a real-time service option to establish the non-home agent-facilitated interactive real-time session such that Real-time Transport Protocol messages that use the real-time service option and that bear interactive real-time content are routed directly to a target destination rather than through a home agent for the mobile station.

8. The method of claim 1 wherein establishing a non-home agent-facilitated interactive real-time session for the mobile station notwithstanding and apart from the existing home agent-facilitated data session comprises establishing the non-home agent-facilitated interactive real-time session for the mobile station prior to the step of receiving from a mobile station an indication of a present need to conduct a interactive real-time session.

9. The method of claim 1 wherein establishing a non-home agent-facilitated interactive real-time session for the mobile station notwithstanding and apart from the existing home agent-facilitated data session comprises establishing the non-home agent-facilitated interactive real-time session for the mobile station subsequent to the step of receiving from a mobile station an indication of a present need to conduct a interactive real-time session.

10. A packet data serving node comprising:
a receiver configured and arranged to receive from a mobile station that already has an existing home agent-facilitated data session an indication of a present need to conduct an interactive real-time session;
a processor operably coupled to the receiver and being configured and arranged to establish a non-home agent-facilitated interactive real-time session for the mobile station notwithstanding and apart from the existing home agent-facilitated data session.

11. The packet data serving node of claim 1 further comprising a memory operably coupled to the processor and serving to store a different Internet Protocol address for the mobile station and that is to be used by the mobile station with respect to the non-home agent-facilitated interactive real-time session than is used by the mobile station for the existing home agent-facilitated data session.

12. The packet data serving node of claim 11 wherein the processor is further configured and arranged to assign the different Internet Protocol address to the mobile station.

13. The packet data serving node of claim 12 wherein the processor is further configured and arranged to assign the different Internet Protocol address using at least one of:
an Internet Protocol Control Protocol-based Internet Protocol address allocation process;
a Remote Authentication Dial-In User Service-based Internet Protocol address allocation process;
a Dynamic Host Configuration Protocol-based Internet Protocol address allocation process.

14. The packet data serving node of claim 10 wherein the processor is further configured and arranged to:
treat traffic as corresponds to the non-home agent-facilitated interactive real-time session as simple Internet Protocol traffic;
treat traffic as corresponds to the existing home agent-facilitated data session as mobile Internet Protocol traffic.

15. The packet data serving node of claim 10 wherein the indication of a present need to conduct a interactive real-time session comprises an interactive real-time call setup message.

16. The packet data serving node of claim 10 wherein the processor is further configured and arranged to use a real-time service option to establish the non-home agent-facilitated interactive real-time session.

17. The packet data serving node of claim 10 wherein the processor comprises means for establishing the non-home agent-facilitated interactive real-time session for the mobile station notwithstanding and apart from the existing home agent-facilitated data session.

18. A method comprising:
at a mobile station:
establishing a home agent-facilitated data session;
establishing a non-home agent-facilitated interactive real-time session notwithstanding and apart from the existing home agent-facilitated data session.

19. The method of claim 18 wherein establishing a home agent-facilitated data session comprises using mobile Internet Protocol.

20. The method of claim 19 wherein establishing a non-home agent-facilitated interactive real-time session comprises using simple Internet Protocol.

21. The method of claim 18 further comprising:
conducting the non-home agent-facilitated interactive real-time session using a real-time service option.

22. The method of claim 21 further comprising:
conducting the home agent-facilitated data session using a non-real-time service option.

23. The method of claim 18 wherein establishing a home agent-facilitated data session comprises establishing a home agent-facilitated data session using a first Internet Protocol address for the mobile station.

24. The method of claim 23 wherein establishing a non-home agent-facilitated interactive real-time session comprises establishing a non-home agent-facilitated interactive real-time session using a second Internet Protocol address for the mobile station that is different than the first Internet Protocol address.

25. The method of claim 24 further comprising:
being assigned the second Internet Protocol address from a packet data serving node.
